(19) United States
(12) Patent Application Publication
(10) Pub. No.: US 2005/0071113 A1
(43) Pub. Date: Mar. 31, 2005

(54) Electronic field device with a sensor unit for process measurement

(76) Inventor: Clemens Heilig, Offenburg (DE)

Correspondence Address: BACON & THOMAS, PLLC, 625 SLATERS LANE, FOURTH FLOOR, ALEXANDRIA, VA, 22314, US

(21) Appl. No.: 10/497,542

(22) PCT Filed: Nov. 30, 2002
(86) PCT No.: PCT/EP02/13535

(30) Foreign Application Priority Data
Dec. 12, 2001 (DE) 101 61 072.6

(51) Int. Cl. G01D 1/00

(52) U.S. Cl. 702/127

(57) ABSTRACT

The invention relates to a field device electronics with a sensor unit for process measurement, wherein the field device electronics is connected over appropriate signal paths with the sensor unit, and wherein the field device electronics receives analog measurement signals of the sensor unit and produces drive signals for the sensor unit and transmits to the sensor unit. According to the invention, the field device electronics includes an analog/digital converter, a microprocessor and a memory unit, wherein the analog measurement signals are digitized by the analog/digital converter and fed to the microprocessor, wherein the microprocessor performs the production of the drive signals according to predetermined program routines, wherein the associated programs are stored in the memory unit.

The invention relates to a field device electronics with sensor unit for process measurements, as defined in the preamble of claim 1.

Practically all sensor units which have been marketed previously for determining the fill levels of liquids and bulk goods using electromechanical transducers, capacitance measurements or conductivity measurements are driven with sinusoidal, alternating voltage, electrical signals. In such case, the alternating signals serve either directly as measuring signals, for example in the case of capacitive or conductive measurements, or for driving electromechanical transducers (Vibronik). These alternating signals are normally produced by means of an analog oscillator and, for further processing, filtered by analog techniques, rectified, and, in the case of limit level switches, compared by means of analog comparators with predetermined threshold values. Microprocessors are, as a rule, only used for linearizing and scaling the signals prepared by means of the analog electronics, as well as for providing time delays, switching hystereses, or inversions.

An object of the invention is to provide a field device electronics utilizing few components but nevertheless widely applicable and easily adjusted to different field conditions.

This object is accomplished, according to the invention, by the features of claim 1. The dependent claims concern advantageous expansions and further developments of the invention.

A main concept of the invention is to reduce the analog circuit components to a minimum and to produce the drive signals for the sensor unit by a microprocessor on the basis of predetermined program routines, which are stored in a memory in the form of the relevant programs therefor. Since the drive signals for the sensor unit are, as a rule, dependent on the measurement signal produced by the sensor unit, the measurement signal is digitized by an analog/digital converter and sent to the microprocessor for further processing. These provisions reduce the analog circuit portion to an absolute minimum, and filtering, feedback loops, temperature compensation, amplification control, signal rectification and comparators are realized in the software of the microprocessor. In the ideal case, a complete field device electronics can be realized in this manner with only one microprocessor and few peripheral components.

In an advantageous embodiment of the invention, the analog/digital converter is integrated as hardware in the microprocessor. It is, however, also possible to use external A/D transducers.

In a further development of the invention, the drive signals are converted into analog drive signals by means of a digital/analog converter, before being sent to the sensor unit, with the analog/digital converter being likewise integrated in the microprocessor in a further development of the invention.

In an especially advantageous embodiment, the sensor unit uses an active electromechanical transducer. The electromechanical transducer produces a measurement, which, in a further development of the invention, is needed for determining and/or monitoring a fill level of a medium in a container, or, in another further development of the invention, for determining and/or monitoring a flow rate of a medium through a pipe system.

In an especially advantageous embodiment of the invention for determining and/or monitoring the fill level of a medium in a container, the active electromechanical transducer uses an oscillating fork having a driver-/receiver-unit. In this embodiment, the receiver unit produces the analog measurement signals for the field device electronics and the field device electronics transmits the drive signals to the driver unit.

In another advantageous embodiment, the sensor unit uses an active capacitive probe for determining and/or monitoring a fill level of a medium in a container.

For producing the drive signals, the function of a bandpass filter and/or a phase shifter and/or an amplifier and/or a frequency switch and/or a rectangular signal generator is advantageously stored in the memory unit as a program which can be executed in the microprocessor.

In an especially advantageous embodiment of the invention, the microprocessor evaluates the measurement signals and produces an output signal based on the evaluation of the measurement signals for further processing in a superordinated unit. For evaluating the measurement signals and for producing the output signal, the function of an effective value formation and/or a comparator and/or a frequency measurement and/or a linearizing and/or a scaling is stored in the memory unit as a program executable in the microprocessor.

Additionally, interferences can be compensated by other functions, such as the function of an amplitude regulation and/or a frequency measurement and/or an impedance calculation, using programs stored in the memory unit and executable in the microprocessor.

In a further advantageous development, the field device electronics and the sensor unit are integrated in a housing.

The described embodiments of the invention have the advantage, that, practically without extra expense, additional functions, such as e.g. frequency switching, exciting of plural modes, production of non-sinusoidal measurement signals, amplitude switching, or tracking, as the case may be, and temperature compensation, are realizable.

Additionally, expensive passive capacitors and/or inductances for filters of narrow tolerances are no longer necessary. And, filters with steeper flanks than possible with analog technology can be realized, while the filter functions no longer show the temperature dependence resulting from temperature dependent analog components.

As well, evaluation functions, such as e.g. sliding average formation, linearizing, scaling, etc., for which, previously, a microprocessor had to be supplied in addition to the analog circuit portion, can be integrated in the microprocessor of the invention.

Furthermore, it is possible to provide an “intelligent” suppression of process-related interferences.

The same hardware can produce various output signals for the field device electronics (4-20 mA, 0-10V, PFM signal, binary switching signal, etc.).

An additional advantage is that completely different measurement methods can be realized on a practically identical hardware platform, this meaning significant savings in the costs of development, permitting, and logistics. Thus, the described field device electronics can be used, for example, both for sensor units using electromechanical transducers and for sensor units using capacitive probes. It is only required to execute the appropriate program in the microprocessor, so that a change of functionality is achieved by a simple changing of the memory contents.

The invention will now be described in greater detail on the basis of the drawings, which show examples of embodiments of the invention as follows:

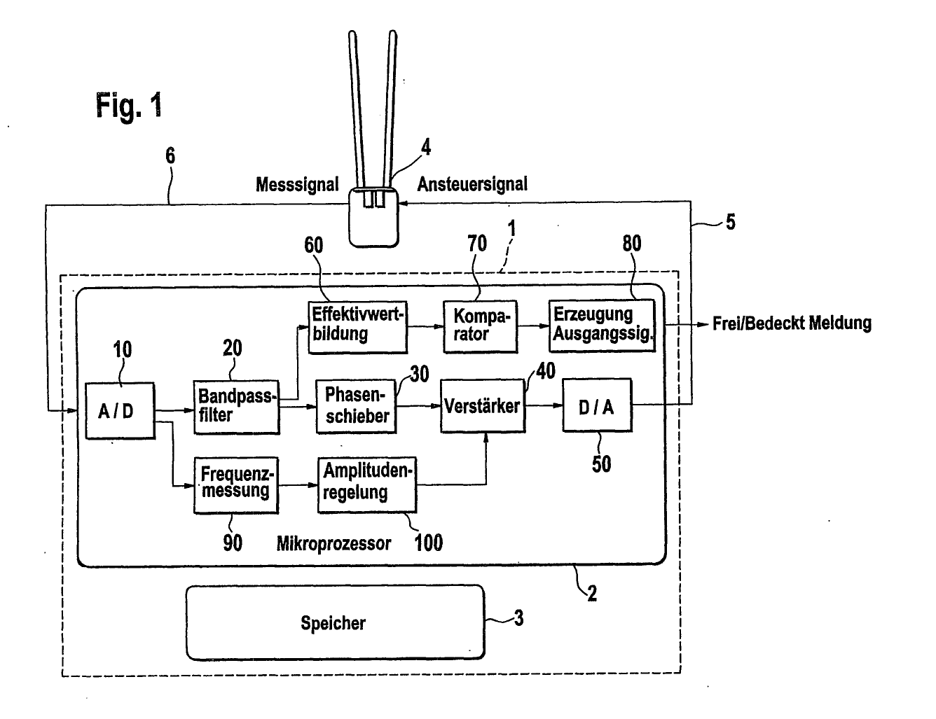

FIG. 1: a schematic drawing of a first embodiment; and

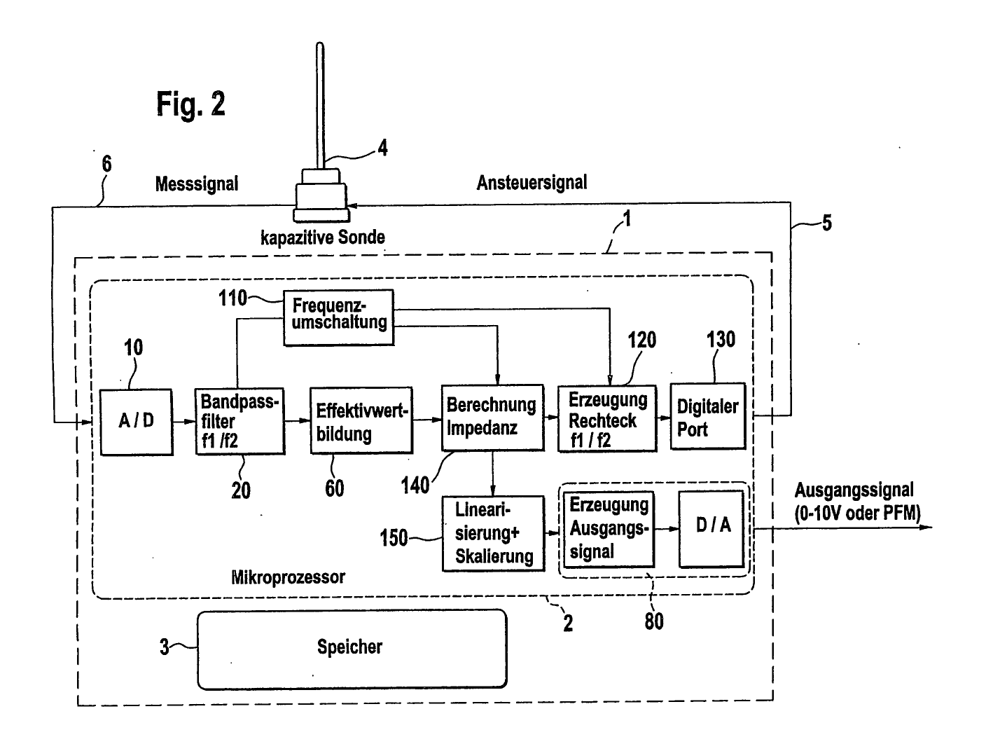

FIG. 2: a schematic drawing of a second embodiment.

As shown in FIG. 1, the first embodiment includes a field device electronics 1 having a sensor unit 4 using an oscillating fork for determining and/or monitoring a fill level of a medium in a container. The illustrated field device electronics 1 includes a microprocessor 2 and a memory unit 3. The field device electronics is connected with the sensor unit 4 over appropriate signal paths 5, 6, with the sensor unit 4 in the illustrated first embodiment being in the form of an oscillation fork, with the signal path 5 serving for transmission of the drive signal from the field device electronics 1 to the sensor unit 4, and the signal path 6 serving for the transmission of the measurement signal from the sensor unit 4 to the field device electronics 1.

The function blocks 10 to 100 illustrated in FIG. 1 are program routines executable by the microprocessor 3, with the associated programs being stored in the memory unit 3, or realized by microprocessor-internal hardware.

Thus, the drive signal for the sensor unit 4 (oscillation fork) is produced by the function blocks 10, 20, 30, 40, 50 from the measurement signal. In this procedure, the function block 10 performs an analog/digital conversion of the measurement signal produced by the sensor unit 4 (oscillation fork). The measurement signal in the illustrated embodiment is an analog signal registered by a piezoelectric receiving transducer and representing the oscillations of the oscillation fork. Function block 20 filters the digitized measurement signal and forwards it to the function block 30. Function block 20 in the illustrated embodiment is a digital bandpass filter of second order for suppressing higher oscillation modes. Function block 30 produces the required phase shift of the drive signal compared with the measurement signal for achieving the correct conditions for the signal feedback for maintaining the oscillations of the oscillation fork 4. Function block 40 amplifies the resulting phase-shifted drive signal and forwards it to the function block 50, with the function block 40 being realized as an amplifier with variable amplification factor. Function block 50 is a digital/analog converter and performs a corresponding transformation of the drive signal. The now analog drive signal, phase-shifted with respect to the measurement signal, is forwarded to the sensor unit. In the illustrated embodiment, it is transmitted to the exciting, piezoelectric transducer of the oscillation fork 4.

Function blocks 90 and 100 are required for compensating for accretions formed on the sensor unit 4. Thus, function block 90 performs a frequency measurement of the measurement signal and function block 100 an amplitude regulation of the amplifier 40. By the frequency measurement, a change in the resonance frequency of the sensor unit caused by an accretion is recognized, along with the accompanying reduction in the oscillation amplitude of the oscillations of the sensor unit. The amplification factor of amplifier 40 is increased to correct the reduction.

Function blocks 60, 70 and 80 are required for evaluating the measurement signal and for producing an output signal. Thus, function block 60 effects the formation of an effective value for the measurement signal, while function block 70 contains a comparator, which produces a free-signal or a covered-signal, depending on the comparison of the measurement signal with a reference value. The “free” or “covered” signal is then issued by the function block 80 as an output signal, with the function block 80 performing here a required adjustment of the output signal for its forwarding to a superordinated unit.

Function block 80 produces an output signal, whose character depends on the intended further use of the output signal, or, as the case may be, on the transmission protocol which is being used. Thus, for example, a 4-20 mA signal, a 0-10V signal, a PFM-signal (pulse frequency modulation signal), a binary switching signal, or a digital code, etc., can be produced. It is, furthermore, imaginable, that the function block 80 produces and issues plural output signals (4-20 mA, 0-10V, PFM-signal, a binary switching signal, etc.) for different transmission protocols, or application purposes, as the case may be. A digital/analog converter for producing certain standardized output signals can be part of function block 80 or realized in its own function block.

With reference now to FIG. 2, the second embodiment includes a field device electronics 1 having a sensor unit 4 in the form of a capacitive probe for determining and/or monitoring a fill level of a medium in a container (not shown). The illustrated field device electronics 1 includes a microprocessor 2 and a memory unit 3. The field device electronics is connected with the sensor unit 4 over appropriate signal paths 5, 6, with the sensor unit 4 in the illustrated second embodiment being in the form of a capacitive probe, with the signal path 5 serving for transmission of the drive signal from the field device electronics 1 to the sensor unit 4 (capacitive probe), and the signal path 6 for the transmission of the measurement signal from the sensor unit 4 (capacitive probe) to the field device electronics 1.

The function blocks 10, 20, 60, 80, 110, 120, 130, 140 and 150 illustrated in FIG. 2 are program routines executable by the microprocessor 2, with the associated programs being stored in the memory unit 3, or realized by microprocessor-internal hardware.

Thus, the drive signal for the sensor unit 4 (capacitive probe) is produced by the function blocks 110, 120, 130. Function block 120, which is realized in the form of a rectangle generator, calculates with different frequencies, depending on the setting of the frequency switch 110. The illustrated embodiment works with two different frequencies f1 and f2, which are transmitted from function block 130, realized in the form of a digital port, alternatingly over the signal path 5 to the capacitive probe 4.

Measurement with two different frequencies, which are alternately selected, offers the advantages, that, on the one hand, a compensation of conductive accretions is possible, and that, on the other hand, a continuous fill level measurement is possible in bulk goods, whose conductivity changes on the basis of external influences. The exact accomplishment of compensation for conductive accretions and fill level measurement in bulk goods of variable conductivity is the subject of another invention, so that the subjects will not be explored here in more detail. Essential in this case is simply that the production of drive signals with different frequencies can be performed by the present invention.

Function blocks 10, 20, 110, 60, 150 and 80 are required for evaluating the measurement signal and for producing an output signal. Thus, function block 10 performs an analog/digital conversion of the analog measurement signal produced by the sensor unit 4, with the analog measurement signal in the illustrated embodiment being an electrical current flowing across the capacitive probe 4. Function block 20 filters the digital measurement signal and forwards it to the function block 60. Function block 20 in the illustrated embodiment is realized in the form of a digital bandpass filter, whose center frequency is set on the basis of the frequency switch 110. Function block 60 accomplishes the formation of an effective value for the filtered measurement signal. Function block 140 determines from the effective value of the filtered measurement signals, depending on the setting of the frequency switch, the impedance of the medium to be measured, with the determined impedance being converted, linearized, and scaled, according to need, into fill level of the medium in the container. Function block 80 produces an output signal, which depends on the intended further use of the output signal, or, as the case may be, on the transmission protocol which is being used. Thus, for example, a 4-20 mA signal, a 0-10V signal, a PFM-signal (pulse frequency modulation signal), a binary switching signal, etc., can be produced. It is, however, imaginable, that the function block 80 produces and issues plural output signals (4-20 mA, 0-10V, PFM-signal, a binary switching signal, etc.) for different transmission protocols, or application purposes, as the case may be. A digital/analog converter for producing certain standardized output signals can be part of function block 80 or realized in its own function block, as in the first embodiment.

The compensation of accretions on the sensor unit 4 is, if needed, also performed in the function block 140 and is, as already indicated, the subject of another invention.

1-14. (canceled)

15. A field device electronics, comprising:
a sensor unit for process measurements, said sensor unit being connected over appropriate signal paths with the field device, and wherein the field device electronics receives analog measurement signals of said sensor unit, produces drive signals for said sensor unit and transmits to the sensor unit;
an analog/digital converter;
a microprocessor; and
a memory unit, wherein:
analog measurement signals are digitized by said analog/digital converter and forwarded to said microprocessor;
said microprocessor accomplishes the production of the drive signals on the basis of predetermined program routines; and
the programs associated therewith are stored in said memory unit.

16. The field device electronics as claimed in claim 15, wherein:
said analog/digital converter is integrated in said microprocessor.

17. The field device electronics as claimed in claim 15, further comprising:
a digital/analog converter, wherein:
the drive signals are converted into analog drive signals by means of said digital/analog converter before being forwarded to said sensor unit.

18. The field device electronics as claimed in claim 17, wherein:
said digital/analog converter is integrated in said microprocessor.

19. The field device electronics as claimed in claim 15, wherein:
said sensor unit is provided in the form of an active electromechanical transducer.

20. The field device electronics as claimed in claim 19, wherein:
said electromechanical transducer produces a measurement signal for determining and/or monitoring a fill level of a medium in a container.

21. The field device electronics as claimed in claim 19, wherein:
said electromechanical transducer produces a measurement for determining and/or monitoring a flow of a medium through a pipe system.

22. The field device electronics as claimed in claim 20, wherein:
said active electromechanical transducer is provided in the form of an oscillation fork having a driver-/receiver-unit;
the receiver unit produces the analog measurement signal and forwards it to the field device electronics; and
the drive signals from the field device electronics are transmitted to said driver unit.

23. The field device electronics as claimed in claim 15, wherein:
said sensor unit is provided in the form of an active, capacitive probe for determining and/or monitoring a fill level of a medium in a container, which probe is driven by the drive signal and transmits a corresponding measurement signal to the field device electronics for evaluation.

24. The field device electronics as claimed in claim 15, wherein:
said memory unit has the function of a bandpass filter and/or a phase shifter and/or an amplifier and/or a frequency switch and/or a rectangular signal generator stored therein as a program executable on said microprocessor for producing the drive signals.

24. The field device electronics as claimed in claim 15, further comprising:
a superordinated unit, wherein:
said microprocessor produces an output signal, on the basis of an evaluation of the measurement signal, for further processing in said superordinated unit.

25. The field device electronics as claimed in claim 24, wherein:
said memory unit has the function of an effective value formation and/or a comparator and/or a frequency measurement and/or a linearizing and/or scaling and/or an impedance calculation stored therein as a program executable in said microprocessor for evaluating the measurement signal and for producing an output signal.

26. The field device electronics as claimed in claim 15, wherein:
said memory unit has the function of an amplitude regulation and/or a frequency measurement and/or an impedance calculation stored therein as a program executable in said microprocessor for compensation of interference.

27. The field device electronics as claimed in claim 15, wherein:
the field device electronics and said sensor unit are integrated in a housing.
